(19) United States
(12) Patent Application Publication
(10) Pub. No.: US 2025/0119723 A1
(43) Pub. Date: Apr. 10, 2025

(54) METHOD FOR RELAY COMMUNICATIONS

(71) Applicant: ZTE CORPORATION, Shenzhen (CN)

(72) Inventors: Wanfu XU, Shenzhen (CN); Mengzhen WANG, Shenzhen (CN); Lin CHEN, Shenzhen (CN); Tao QI, Shenzhen (CN)

(73) Assignee: ZTE CORPORATION, Shenzhen (CN)

(21) Appl. No.: 18/985,388

(22) Filed: Dec. 18, 2024

Related U.S. Application Data
(63) Continuation of application No. PCT/CN2022/122768, filed on Sep. 29, 2022.

(51) Int. Cl. H04W 8/00; H04W 40/22; H04W 88/04

(52) U.S. Cl. CPC H04W 8/005; H04W 40/22; H04W 88/04

(57) ABSTRACT

A wireless communication method for use in a first wireless terminal is disclosed. The method comprises transmitting, to a second wireless terminal, a message associated with a discovery of a relay terminal, wherein the message comprises information associated with at least one network slice supported by the relay terminal.

### CROSS-REFERENCE TO RELATED PATENT APPLICATIONS

This application is a Continuation of PCT Application No. PCT/CN/2022/122768,filed Sep. 29, 2022, incorporated herein by reference in its entirety.

### TECHNICAL FIELD

This document is directed generally to wireless communications, in particular 5^{th} generation wireless communications, and in more particular to relay communications.

### BACKGROUND

With the development of wireless multimedia services, demands for high data rate and great user experience continuously increase, resulting in higher requirements of the system compacity and coverage of conventional cellular networks. On the other hand, demands for proximity services also increase because of application scenarios such as public security, social network, near-field data sharing and local advertisement. Traditionally, the cellular network using base station as the center may have obvious limitations on supporting the high data rates and the proximity service. In order to satisfy such requirements, device-to-device (D2D) communication technology is proposed. By applying the D2D communication technology, burden of the cellular network can be relieved, power consumption of the user equipment (UE) can be reduced, the data rate can be increased and the robustness of the network infrastructure can be improved. Thus, the demands for high data rate and proximity services are greatly satisfied. In this context, D2D communication technology is also named proximity services (ProSe) or sidelink communications, wherein an interface between the UEs is called PC5 interface.

### SUMMARY

For supporting applications and services in a broader scope (e.g., indoor relay communication, smart agriculture, smart factory, public security, etc.), sidelink-based relay communications may be used to extend the coverage and improve the power consumption. For example, the sidelink-based communications may be applied in two application scenarios shown in FIG. 1:

1) UE-to-Network relay (Pattern 1): This type of relay is used for the UE in a weak/no coverage area. In FIG. 1, a UE1 in the weak/no coverage area is allowed to communicate with the network (e.g., base station) via a UE2 under a coverage of the network. The UE-to-Network relay may help the network operator to extend the coverage and increase the capacity of the network. Note that, in FIG. 1, the UE1 may be called remote UE and the UE2 may be called UE-to-Network relay.

2) UE-to-UE relay (Pattern 2): For an emergency scenario (e.g., earthquake) of the network working abnormally or for extending a sidelink communication range, the UEs may be allowed to communicate with each other via relay UE(s). For example, UE3 and UE4 in FIG. 1 communicate with each other via a UE5 or multiple relay UEs. The UE5 may be called UE-to-UE relay.

In long term evolution (LTE), two UE-to-Network relay technical solutions are provided, i.e., internet protocol (IP) based layer (Layer 3 (L3)) and access stratum layer (Layer 2 (L2)). Note that a Layer 3 relay forwards data based on the target IP address/port number and a Layer 2 relay performs route forwarding of the control plane and user plane data, so as to allow the network operator (i.e., core network (CN) network elements and base stations) to effectively manage remote devices (i.e., remote UEs). Because of significant differences between new radio (NR) sidelink communications and LTE sidelink communications (e.g., on frame structure, quality of service (QOS) processing, bearer configuration and establishment, etc.), LTE based sidelink relay technical solutions cannot be applied to the 5G/NR system. Thus, new technical solutions for a 5G/NR system or future communication system are required.

For example, the mobile UE with inferior signal quality or outside network coverage may require at least one relay UE to relay data with the network. Therefore, how to discover and/or select/reselect the relay UE becomes a topic to be discussed.

This document relates to methods, systems, and devices for relay communications, and in particular to methods, systems, and devices for UE-to-UE relay communication.

The present disclosure relates to a wireless communication method for use in a first wireless terminal. The method comprises
transmitting, to a second wireless terminal, a message associated with a discovery of a relay terminal,
wherein the message comprises information associated with at least one network slice supported by the relay terminal.

Various embodiments may preferably implement the following features:

Preferably or in some embodiments, the message is a discovery message.

Preferably or in some embodiments, the first wireless terminal is the relay terminal.

Preferably or in some embodiments, the message is a discovery solicitation message.

Preferably or in some embodiments, the message further comprises a relay indication indicating at least one of a number of hops of transmitting the message or a maximum number of hops of transmitting the message.

Preferably or in some embodiments, the wireless communication method further comprises receiving, from the second wireless terminal, a discovery response message.

Preferably or in some embodiments, the relay terminal is for a link between two wireless terminals or between a wireless terminal and a wireless network node.

Preferably or in some embodiments, the information of the at least one network slice comprises at least one signal network slice selection assistance information of the at least one network slice.

The present disclosure relates to a wireless communication method for use in a second wireless terminal. The method comprises:
receiving, from a first wireless terminal, a message associated with a discovery of a relay terminal,
wherein the message comprises information associated with at least one network slice supported by the relay terminal.

Various embodiments may preferably implement the following features:

Preferably or in some embodiments, the message is a discovery message.

Preferably or in some embodiments, the first wireless terminal is the relay terminal.

Preferably or in some embodiments, the message is a discovery solicitation message.

Preferably or in some embodiments, the message further comprises a relay indication indicating at least one of a number of hops of transmitting the message or a maximum number of hops of transmitting the message.

Preferably or in some embodiments, the second wireless terminal supports at least one of the at least one network slice, and the method further comprises transmitting, to the first wireless terminal, a discovery response message.

Preferably or in some embodiments, the second wireless terminal supports at least one of the at least one network slice, and the method further comprises transmitting, to a third wireless terminal, the message.

Preferably or in some embodiments, a number indicated by a relay indication in the message transmitted to the third wireless terminal is acquired by decrementing a number indicated by a relay indication in the message received from the first wireless terminal by 1.

Preferably or in some embodiments, the relay terminal is for a link between two wireless terminals or between a wireless terminal and a wireless network node.

Preferably or in some embodiments, the information associated with the at least one network slice comprises at least one signal network slice selection assistance information of the at least one network slice.

The present disclosure relates to a wireless communication method for use in a fourth wireless terminal. The method comprises:
transmitting, to a fifth wireless terminal, a message associated with a discovery of a relay terminal,
wherein the message comprises at least one quality-of-service, QoS, parameter associated with the relay terminal.

Various embodiments may preferably implement the following features:

Preferably or in some embodiments, the message is a discovery message, a PC5 sidelink message or a PC5 radio link control message.

Preferably or in some embodiments, the fourth wireless terminal is the relay terminal.

Preferably or in some embodiments, the at least one QoS parameter is supported by the relay terminal.

Preferably or in some embodiments, the message is a discovery solicitation message, a PC5 sidelink message or a PC5 radio link control message.

Preferably or in some embodiments, the message further comprises a relay indication indicating at least one of a number of hops of transmitting the message or a maximum number of hops of transmitting the message.

Preferably or in some embodiments, the method further comprises receiving, from the fifth wireless terminal, a discovery response message.

Preferably or in some embodiments, the at least one QoS parameter is at least one end-to-end QoS parameter for a link between a source terminal of the link and a target terminal of the link or at least one remaining QoS parameter for a relay link between the fourth terminal and a target terminal of the relay link.

Preferably or in some embodiments, the relay terminal is for a link between two wireless terminals or between a wireless terminal and a wireless network node.

Preferably or in some embodiments, the at least one QoS parameter comprises at least one of a packet delay budget, a packet error rate, or a time stamp associated with a transmission the message.

The present disclosure relates to a wireless communication method for use in a fifth wireless terminal. The method comprises:
receiving, from a fourth wireless terminal, a message associated with a discovery of a relay terminal,
wherein the message comprises at least one quality-of-service, QoS, parameter associated with the relay terminal.

Various embodiments may preferably implement the following features:

Preferably or in some embodiments, the message is a discovery message, a PC5 sidelink message or a PC5 radio link control message.

Preferably or in some embodiments, the fourth wireless terminal is the relay terminal.

Preferably or in some embodiments, the at least one QoS parameter is supported by the relay terminal.

Preferably or in some embodiments, the message is a discovery solicitation message, a PC5 sidelink message or a PC5 radio link control message.

Preferably or in some embodiments, the message further comprises a relay indication indicating at least one of a number of hops of transmitting the message or a maximum number of hops of transmitting the message.

Preferably or in some embodiments, the fifth wireless terminal supports the at least one QoS parameter, and the method further comprises transmitting, to the fourth wireless terminal, a discovery response message.

Preferably or in some embodiments, the fifth wireless terminal supports the at least one QoS parameter, and the method further comprises transmitting, to a sixth wireless terminal, the message.

Preferably or in some embodiments, the at least one QoS parameter is at least one end-to-end QoS parameter for a link between a source terminal of the link and a target terminal of the link or at least one remaining QoS parameter for a relay link between the fourth terminal and a target terminal of the relay link.

Preferably or in some embodiments, the relay terminal is for a link between two wireless terminals or between a wireless terminal and a wireless network node.

Preferably or in some embodiments, the at least one QoS parameter comprises at least one of a packet delay budget, a packet error rate or a time stamp associated with a transmission the message.

The present disclosure relates to a wireless communication method for use in a seventh wireless terminal. The method comprises:
transmitting, to an eighth wireless terminal on a link between a source terminal and a target terminal, a message associated with requesting a measurement report associated with each hop on the link,
wherein the message comprises a link identifier associated with the link.

Various embodiments may preferably implement the following features:

Preferably or in some embodiments, the message further comprises a relay indication configured to indicate a request for the measurement report associated with each hop on the link.

Preferably or in some embodiments, the link identifier comprises at least one of an end-to-end PC5 link identifier of the link, an identifier of the source terminal or an identifier of the target terminal.

Preferably or in some embodiments, the wireless communication method further comprises receiving, from the eighth wireless terminal, the measurement report associated with each hop between the seventh wireless terminal and the target terminal.

Preferably or in some embodiments, the wireless communication method further comprises transmitting, to a ninth wireless terminal on the link, the measurement report associated with each hop between the ninth wireless terminal and the target terminal.

Preferably or in some embodiments, the measurement report comprise reference signal received power of each hop on the link.

The present disclosure relates to a wireless communication method for use in an eighth wireless terminal. The method comprises:
receiving, from a seventh wireless terminal of a link between a source terminal and a target terminal, a message associated with requesting a measurement report associated with each hop on the link,
wherein the message comprises a link identifier associated with the link.

Various embodiments may preferably implement the following features:

Preferably or in some embodiments, the message further comprises a relay indication configured to indicate a request for the measurement report associated with each hop on the link.

Preferably or in some embodiments, the link identifier comprises at least one of an end-to-end PC5 link identifier of the link, an identifier of the source terminal or an identifier of the target terminal.

Preferably or in some embodiments, the wireless communication method further comprises transmitting, to the seventh relay terminal, the measurement report associated with each hop between the seventh wireless terminal and the target terminal.

Preferably or in some embodiments, the wireless communication method further comprises transmitting, to a tenth relay terminal, the message associated with requesting the measurement report of each hop on the link.

Preferably or in some embodiments, the wireless communication method further comprises receiving, from the tenth relay terminal, the measurement report associated with each hop between the eighth wireless terminal and the target terminal.

Preferably or in some embodiments, the measurement results comprise reference signal received power of each hop on the link.

The present disclosure relates to a wireless communication method for use in an eleventh wireless terminal, the method comprising:
transmitting, to a twelfth wireless terminal on a link between a source terminal and a target terminal, a first measurement report associated with each hop on the link between the twelfth wireless terminal and the target terminal,
wherein the first measurement report is identified by a link identifier associated with the link.

Various embodiments may preferably implement the following features:

Preferably or in some embodiments, the link identifier comprises at least one of an end-to-end PC5 link identifier of the link, an identifier of the target terminal or an identifier of the source terminal.

Preferably or in some embodiments, the wireless communication method further comprises receiving, from the source terminal, a configuration message associated with the measurement report.

Preferably or in some embodiments, the wireless communication method further comprises receiving, from a thirteenth wireless terminal on the link, a second measurement report associated with each hop on the link between the eleventh wireless terminal and the target terminal, wherein the second measurement report is identified by the link identifier associated with the link.

Preferably or in some embodiments, the measurement report comprises reference signal received power of each hop on the link.

The present disclosure relates to a wireless communication method for use in a source terminal, the method comprising:
transmitting, to a target terminal to which the source terminal connects via at least one relay terminal, a configuration message associated with a measurement report associated with each hop on a link between the source terminal and the target terminal, and
receiving, from one of the at least one relay terminal, the measurement report.

Various embodiments may preferably implement the following feature:

Preferably or in some embodiments, the measurement report comprises reference signal received power of each hop.

The present disclosure relates to a wireless communication method for use in a wireless network node. The method comprises:
transmitting, to a wireless terminal, a configuration message associated with at least one discovery model capable of being used by the wireless terminal for discovering a relay terminal and/or an indication of supporting a terminal-to-terminal relay.

Various embodiments may preferably implement the following features:

Preferably or in some embodiments, the wireless communication method further comprises receiving, from the wireless terminal, capability information of at least one discovery model supported by the wireless terminal.

Preferably or in some embodiments, the at least one discovery model capable of being used by the wireless terminal for discovering the relay terminal is determined based on the capability information.

The present disclosure relates to a wireless communication method for use in a wireless terminal. The method comprises:
receiving, from a wireless network node, a configuration message associated with at least one discovery model capable of being used by the wireless terminal for discovering a relay terminal and/or an indication of supporting a terminal-to-terminal relay.

Various embodiments may preferably implement the following feature:

Preferably or in some embodiments, the wireless communication method further comprises transmitting, to the wireless network node, capability information of at least one discovery model supported by the wireless terminal.

The present disclosure relates to a wireless communication method for use in a relay terminal. The method comprises:
transmitting, to a neighbor terminal, an announcement message comprising a list of vicinity terminals of the relay terminal.

Various embodiments may preferably implement the following features:

Preferably or in some embodiments, the number of vicinity terminals in the list is greater than 0.

Preferably or in some embodiments, the announcement message further comprises reference signal received power between the relay terminal and each of vicinity terminals.

Preferably or in some embodiments, reference signal received power between the relay terminal and each vicinity terminal in the list is greater than a threshold.

The present disclosure relates to a first wireless terminal. The fire wireless terminal comprises:
a communication unit, configured to transmit, to a second wireless terminal, a message associated with a discovery of a relay terminal,
wherein the message comprises information associated with at least one network slice supported by the relay terminal.

Various embodiments may preferably implement the following feature:

Preferably or in some embodiments, the first wireless terminal further comprises a processor configured to perform any of aforementioned wireless communication methods.

The present disclosure relates to a second wireless terminal. The second wireless terminal comprises:
a communication unit, configured to receive, to a second wireless terminal, a message associated with a discovery of a relay terminal,
wherein the message comprises information associated with at least one network slice supported by the relay terminal.

Various embodiments may preferably implement the following feature:

Preferably or in some embodiments, the second wireless terminal further comprises a processor configured to perform any of aforementioned wireless communication methods.

The present disclosure relates to a fourth wireless terminal. The fourth wireless terminal comprises:
a communication unit, configured to transmit, to a fifth wireless terminal, a message associated with a discovery of a relay terminal,
wherein the message comprises at least one quality-of-service, QoS, parameter associated with the relay terminal.

Various embodiments may preferably implement the following feature:

Preferably or in some embodiments, the fourth wireless terminal further comprises a processor configured to perform any of aforementioned wireless communication methods.

The present disclosure relates to a fifth wireless terminal. The fifth wireless terminal comprises:
a communication unit, configured to receive, from a fourth wireless terminal, a message associated with a discovery of a relay terminal,
wherein the message comprises at least one quality-of-service, QoS, parameter associated with the relay terminal.

Various embodiments may preferably implement the following feature:

Preferably or in some embodiments, the fifth wireless terminal further comprises a processor configured to perform any of aforementioned wireless communication methods.

The present disclosure relates to a seventh wireless terminal. The seventh wireless terminal comprises:
a communication unit, configured to transmit, to an eighth wireless terminal on a link between a source terminal and a target terminal, a message associated with requesting a measurement report associated with each hop on the link,
wherein the message comprises a link identifier associated with the link.

Various embodiments may preferably implement the following feature:

Preferably or in some embodiments, the seventh wireless terminal further comprises a processor configured to perform any of aforementioned wireless communication methods.

The present disclosure relates to an eighth wireless terminal. The eighth wireless terminal comprises:
a communication unit, configured to receive, from a seventh wireless terminal of a link from a source terminal to a target terminal, a message associated with requesting a measurement report associated with each hop on the link,
wherein the message comprises a link identifier associated with the link.

Various embodiments may preferably implement the following feature:

Preferably or in some embodiments, the eighth wireless terminal further comprises a processor configured to perform any of aforementioned wireless communication methods.

The present disclosure relates to an eleventh wireless terminal. The eleventh wireless terminal comprises:
a communication unit, configured to transmit, to a twelfth wireless terminal on a link between a source terminal and a target terminal, a first measurement report associated with each hop on the link between the twelfth wireless terminal and the target terminal,
wherein the first measurement report is identified by a link identifier associated with the link.

Various embodiments may preferably implement the following feature:

Preferably or in some embodiments, the eleventh wireless terminal further comprises a processor configured to perform any of aforementioned wireless communication methods.

The present disclosure relates to a source terminal. The source terminal comprises: a communication unit, configured to transmit, to a target terminal to which the source terminal connects via at least one relay terminal, a configuration message associated with a measurement report associated with each hop on a link between the source terminal and the target terminal, and receive, from one of the at least one relay terminal, the measurement report.

Various embodiments may preferably implement the following feature:

Preferably or in some embodiments, the source terminal further comprises a processor configured to perform any of aforementioned wireless communication methods.

The present disclosure relates to a wireless network node. The wireless network node comprises:
a communication unit, configured to transmit, to a wireless terminal, a configuration message associated with at least one discovery model capable of being used by the wireless terminal for discovering a relay terminal and/or an indication of supporting a terminal-to-terminal relay.

Various embodiments may preferably implement the following feature:

Preferably or in some embodiments, the wireless network node further comprises a processor configured to perform any of aforementioned wireless communication methods.

The present disclosure relates to a wireless terminal. The wireless terminal comprises:
a communication unit, configured to receive, from a wireless network node, a configuration message associated with at least one discovery model capable of being used by the wireless terminal for discovering a relay terminal and/or an indication of supporting a terminal-to-terminal relay.

Various embodiments may preferably implement the following feature:

Preferably or in some embodiments, the wireless terminal further comprises a processor configured to perform any of aforementioned wireless communication methods.

The present disclosure relates to a relay terminal. The relay terminal comprises:
a communication unit, configured to transmit, to a neighbor terminal, an announcement message comprising a list of vicinity terminals of the relay terminal.

Various embodiments may preferably implement the following feature:

Preferably or in some embodiments, the relay terminal further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of scenarios of sidelink relay communication.

FIG. 2 shows a schematic diagram of a network according to an embodiment of the present disclosure.

FIG. 3 shows a schematic diagram of a direct discovery with Model A according to an embodiment of the present disclosure.

FIG. 4 shows a schematic diagram of a direct discovery with Model B according to an embodiment of the present disclosure.

FIG. 5 shows a schematic diagram of a procedure associated with supporting slice information in the discovery model A according to an embodiment of the present disclosure.

FIG. 6 shows a schematic diagram of a procedure associated with supporting slice information in the discovery model B according to an embodiment of the present disclosure.

FIG. 7 shows a schematic diagram of a procedure associated with supporting quality of service (QOS) control in the discovery model A according to an embodiment of the present disclosure.

FIG. 8 shows a schematic diagram of a procedure associated with supporting quality of service (QOS) control in the discovery model B according to an embodiment of the present disclosure.

FIG. 9 shows a schematic diagram of a procedure associated with supporting per hop reference signal received power (RSRP) measurement and report (per hop configuration) according to an embodiment of the present disclosure.

FIG. 10 shows a schematic diagram of a procedure associated with supporting per hop RSRP measurement and report (per hop configuration) according to an embodiment of the present disclosure.

FIG. 11 shows a schematic diagram of a procedure associated with supporting discovery model capability according to an embodiment of the present disclosure.

FIG. 12 shows a schematic diagram of a procedure associated with Model A U2U discovery according to an embodiment of the present disclosure.

FIG. 13 shows an example of a schematic diagram of a wireless terminal according to an embodiment of the present disclosure.

FIG. 14 shows an example of a schematic diagram of a wireless network node according to an embodiment of the present disclosure.

FIGS. 15 to 22 show flowcharts of methods according to embodiment of the present disclosure.

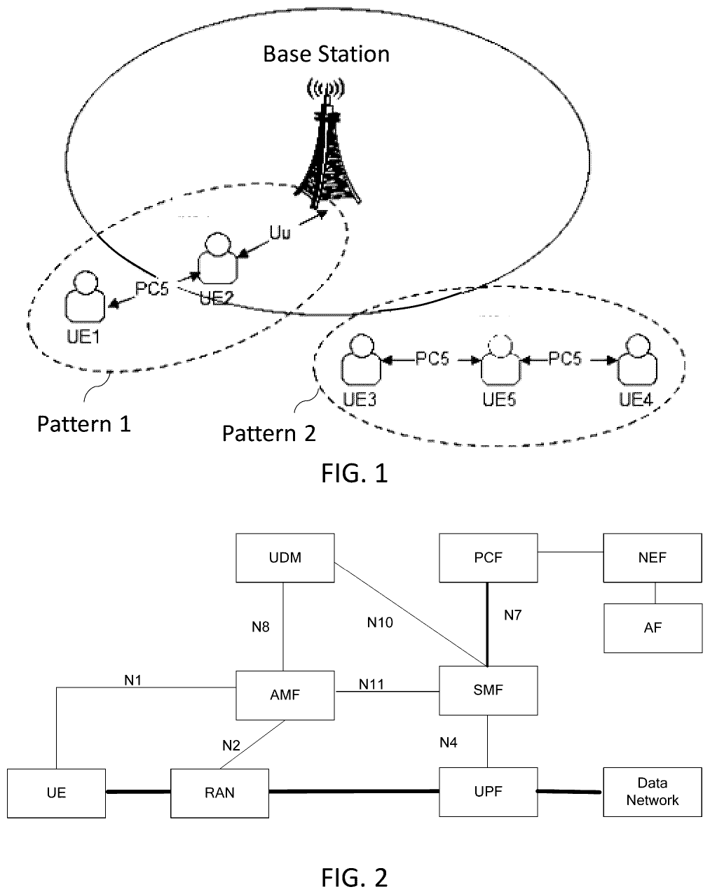

### DETAILED DESCRIPTION

FIG. 2 shows a schematic diagram of a network (architecture) according to an embodiment of the present disclosure. In FIG. 2, the network comprises the following network functions/entities:
1) UE: User Equipment
2) RAN: Radio Access Network

In the present disclosure, the RAN may be equal to a RAN node or a next-generation RAN (NG-RAN) (node).
3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.
4) SMF: Session Management Function

The SMF includes the following functionalities: session establishment, modification and release, UE IP address allocation & management (including optional authorization functions), selection and control of the User Plane (UP) function, downlink data notification. The SMF can subscribe the mobility related events and information from the AMF.
5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QOS) handling for the UP, downlink packet buffering and downlink data notification triggering, etc.
6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which are used for the AMF to select a proper SMF. The AMF and the SMF get the subscription from UDM. The subscription data is stored in the Unified Data Repository (UDR). The UDM uses such data upon reception of a request from the AMF or the SMF.
7) PCF: Policy Control Function

The PCF supports unified policy framework to govern network behavior. The PCF provides an access management policy to the AMF, or a session management policy to the SMF, and/or a UE policy to the UE. The PCF can access the UDR to obtain subscription information relevant for policy decisions. The PCF may also generate the policy to govern network behavior based on the subscription and an indication from an application function (AF). Then, the PCF can provide policy rules to CP functions (e.g., the AMF and/or the SMF) to enforce the CP functions.
8) NEF: Network Exposure Function

The NEF supports exposure of capability and events of the network towards the AF. A third party AF can invoke the service provided by the network via the NEF and the NEF performs authentication and authorization of the third party applications. The NEF also provides a translation of the information exchanged with the AF and information exchanged with the internal NF.
9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

In an embodiment, Direct Link Establishment Request message is used for a sidelink UE (e.g., source UE) to establish a direct link or indirect link with another sidelink UE (e.g., target UE). The direct link means that the source UE communicates with the target UE directly. On the other hand, the indirect link means that the source UE communicates with the target UE via at least one relay UE.

In an embodiment, a relay indication (e.g., relay indication) may be included in the Direct Link Establishment Request message. If the relay indication is (configured as) or indicates enable, the communication between the source UE and the target UE via the relay UE is allowed. If relay indication is (configured as) or indicates disable, the communication between the source UE and the target UE via the relay UE is not allowed and/or only the direct communication between source UE and target UE is allowed.

In an embodiment, a proximity service (Prose) discovery procedure can be model A or model B, where:

Model A: involves one UE announcing “I am here”

Model B: involves one UE asking “who is there” and/or “are you there”.

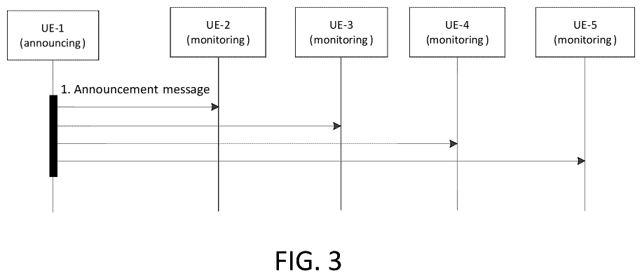

FIG. 3 shows a schematic diagram of a direct discovery with Model A according to an embodiment of the present disclosure. In FIG. 3, the UE-1 transmits/broadcasts announcement messages to each of the UE-2, UE-3, UE-4 and UE-5, to acknowledge each of the UE-2, UE-3, UE-4 and UE-5 that the UE-1 may be a candidate for the relay UE.

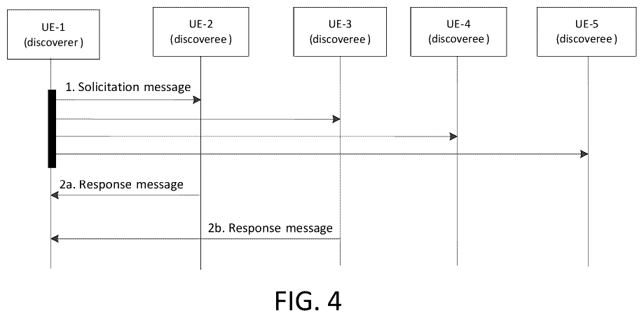

FIG. 4 shows a schematic diagram of a direct discovery with Model B according to an embodiment of the present disclosure. In FIG. 4, the UE-1 transmits/broadcasts discovery solicitation messages to each of the UE-2, UE-3, UE-4 and UE-5. The discovery solicitation message is used for a sidelink UE (e.g., source UE or UE-1 in FIG. 4) to establish a direct link or an indirect link with another sidelink UE (e.g., target UE or one of UE-2, UE-3, UE-4 and UE-5 in FIG. 4). If the target UE receiving the discovery solicitation message is capable of building or supporting the direct link or the indirect link with the source UE, the target UE transmits a discovery response message to the source UE. In FIG. 4, the UE-2 and UE-3 are able to build or support the direct link or the indirect link with the UE-1. Thus, the UE-2 and UE-3 transmit the discovery response message to the UE-1.

In the present disclosure, a message may comprise an identifier of one certain UE, so as to identify this certain UE or a link to the certain UE.

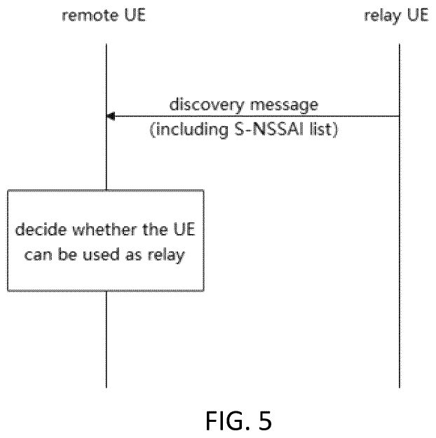

FIG. 5 shows a schematic diagram of a procedure associated with supporting slice information in the discovery model A according to an embodiment of the present disclosure. The procedure in FIG. 5 comprises:

Step 501: The relay UE broadcasts a discovery message including an S-NSSAI list. The S-NSSAI in the list is/indicates the network slice(s) for which the relay UE support as a relay.

Step 502: After receiving the discovery message from the relay UE, the remote UE can decide whether the relay UE can be (re) selected as the relay.

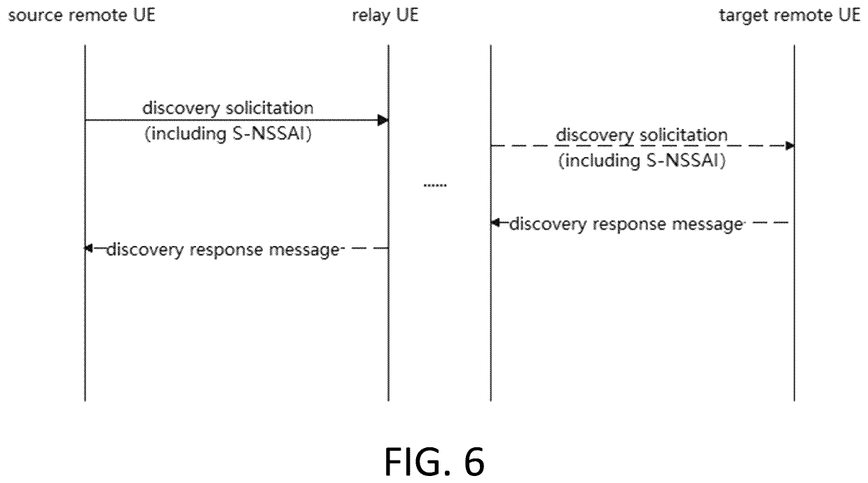

FIG. 6 shows a schematic diagram of a procedure associated with supporting slice information in the discovery model B according to an embodiment of the present disclosure. The procedure in FIG. 6 comprises:

Step 601: The remote UE broadcasts a discovery solicitation message including S-NSSAI and relay indication, where the relay indication indicates how many hops that the source UE wants the discovery message to be forwarded away. Note that the remote UE in this embodiment may be the source UE or the relay UE receiving the discovery solicitation message in FIG. 6.

Step 602: Upon/after receiving the discovery solicitation message from the remote UE, the relay UE checks whether it can support the network slice indicated by the S-NSSAI in the discovery solicitation message as a relay. If the relay UE cannot support the network slice indicated by the S-NSSAI, the relay UE does nothing. If the relay UE supports the network slice indicated by the value indicated by the S-NSSAI and the relay indication in the received discovery solicitation message indicates is greater than 1, the relay UE broadcast a new discovery solicitation message including the S-NSSAI and the relay indication. The value indicated by the relay indication in the new discovery solicitation is acquired by decrementing 1 from that indicated by the relay indication in the received discovery solicitation message. That is the value is decremented by one for each hop. Note that,

Step 603: After the target remote UE receives the discovery solicitation message, the target remote UE can decide whether to response the discovery message (i.e., transmitting a discovery response message.

Step 604: If receiving the discovery response message, the relay UE decide whether to retransmit the discovery response message. until the source remote UE receives the discovery response message.

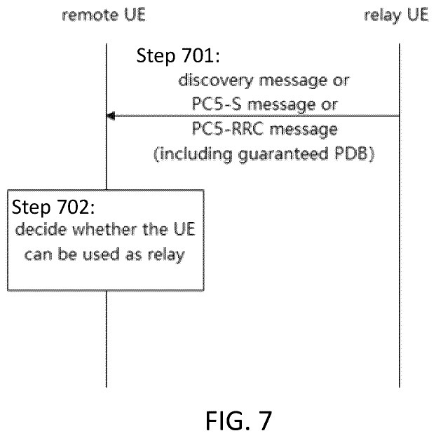

FIG. 7 shows a schematic diagram of a procedure associated with supporting quality of service (QOS) control in the discovery model A according to an embodiment of the present disclosure. The procedure in FIG. 7 comprises:

Step 701: The relay UE broadcasts a discovery message or transmits a PC5-S message or transmits a PC5-RRC message including QoS parameter(s). The QoS parameter(s) comprises at least one of a guaranteed PDB (Packed Delay Budget), a PER or a time stamp associated with a transmission of the discovery message, PC5-S message or PC5-RRC message. In an embodiment, the guaranteed PDB refers to the best PDB for which the relay UE can support as a relay. In an embodiment, the time stamp indicates the time of broadcasting/transmitting the discovery message, PC5-S message or PC5-RRC message.

Step 702: When/after receiving the discovery message from relay UE, the remote UE decides whether the relay UE can be (re) selected as the relay.

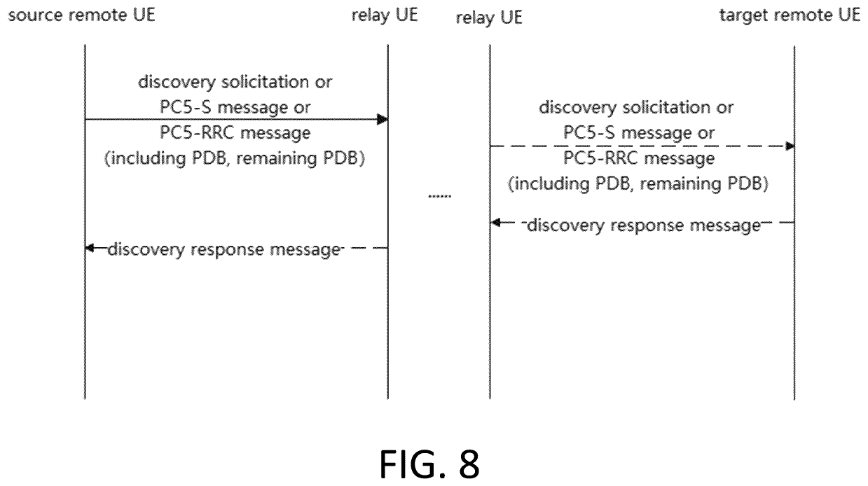

FIG. 8 shows a schematic diagram of a procedure associated with supporting quality of service (QOS) control in the discovery model B according to an embodiment of the present disclosure. The procedure in FIG. 8 comprises:

Step 801: The remote UE broadcasts a discovery solicitation message or transmits a PC5-S message or transmits a PC5-RRC message including QoS parameter(s) and/or a relay indication, The QoS parameter(s) comprises at least one of an end-to-end PDB, a remaining PDB, an end-to-end PER, a remaining PER or a time stamp associated with a transmission of the discovery solicitation message, PC5-S message or PC5-RRC message. The relay indication indicates how many hops that the source UE wants the discovery message to be forwarded away. In an embodiment, the end-to-end PDB refers to the PDB for the link between the source UE and the target UE and the remaining PDB refers to available PDB for the remaining hops (e.g., from the remote UE to the target UE). Similarly, the end-to-end PER refers to the PER for the link between the source UE and the target UE and the remaining PER refers to available PER for the remaining hops. Note that the remote UE in this step may be the source UE or a relay UE receiving the discovery solicitation message from the source UE or another relay UE. In an embodiment, the time stamp indicates the time of broadcasting/transmitting the discovery solicitation message, PC5-S message or PC5-RRC message. In an embodiment of the remote UE broadcasting/transmitting the discovery solicitation message, PC5-S message or PC5-RRC message in response to receiving corresponding message from another remote UE (e.g., source remote UE or a relay UE), the time stamp may indicate the time of receiving the corresponding message.

Step 802: Upon/after receiving the discovery solicitation message from the remote UE, the relay UE checks whether it can support the QoS parameter(s). If the relay UE cannot support the QoS parameter(s), the relay UE does nothing. If the relay UE supports the QoS parameter(s) and the value indicated by the relay indication is greater than 1, the relay UE broadcasts a new discovery solicitation message including the QoS parameter(s). Note that if the QoS parameter(s) comprises the remaining PDB, the remaining PDB transmitted in the new discovery solicitation message is acquired by subtracting a PDB of the relay UE (e.g., between the relay UE and the remote UE) from the remaining PDB/end-to-end PDB in the received discovery solicitation message. Similarly, if the QoS parameter(s) comprises the remaining PER, the remaining PER transmitted in the new discovery solicitation message is acquired by subtracting a PER of the relay UE (e.g., between the relay UE and the remote UE) from the remaining PER/end-to-end PER in the received discovery solicitation message.

Step 803: After receiving the discovery solicitation message, the target remote UE can decide whether to response the discovery message.

Step 804: Upon/after receiving a discovery response message, the relay UE can decide whether to response the discovery solicitation message.

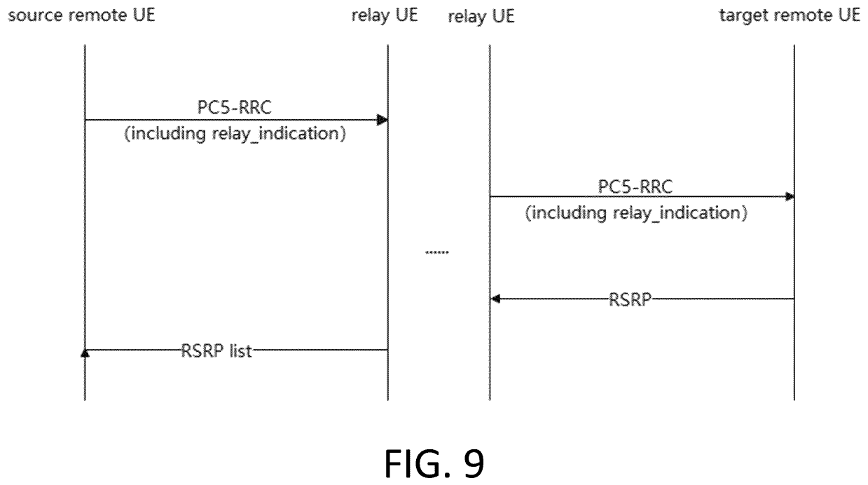

FIG. 9 shows a schematic diagram of a procedure associated with supporting per hop reference signal received power (RSRP) measurement and report (per hop configuration) according to an embodiment of the present disclosure. The procedure shown in FIG. 9 comprises:

Step 901: The source e remote UE sends a PC5-RRC message (e.g., RRCReconfigurationSidelink-→sl-MeasConfig) to relay UE. The PC5-RRC message may include at least one of a source UE identifier a target UE identifier, an end-to-end PC5 link identifier or relay indication. The source UE identifier and/or the target UE identifier and/or the end-to-end PC5 link identifier may be used to identify a PC5 link on which per hop RSRP should be measured. The relay indication may be used to indicate that the per hop RSRP should be measured and/or that the relay UE should report the hop RSRPs of the hop between the source UE and the relay UE and the following hops RSRP on the PC5 link.

Step 902: Upon/after receiving the PC5-RRC message from the source remote UE, the relay UE measures the RSRP between the source remote UE and the relay UE and generate a new PC5 RRC message (e.g., measurement configuration) which require the next relay UE/target remote UE to measure and report the RSRP of next hop.

Step 903: The relay UE receives the PC5-RRC message comprising a measurement report (e.g., MeasurementReportSidelink) from the next hop relay UE/target remote UE. The measurement report includes RSRP list which is per hop RSRP between the relay UE and target remote UE.

Step 904: Upon/after receiving the RSRP list, the relay UE generates a new measurement result which includes the received RSRP list and the RSRP between source remote UE and relay UE. The relay UE transmits the new measurement result to the source remote UE.

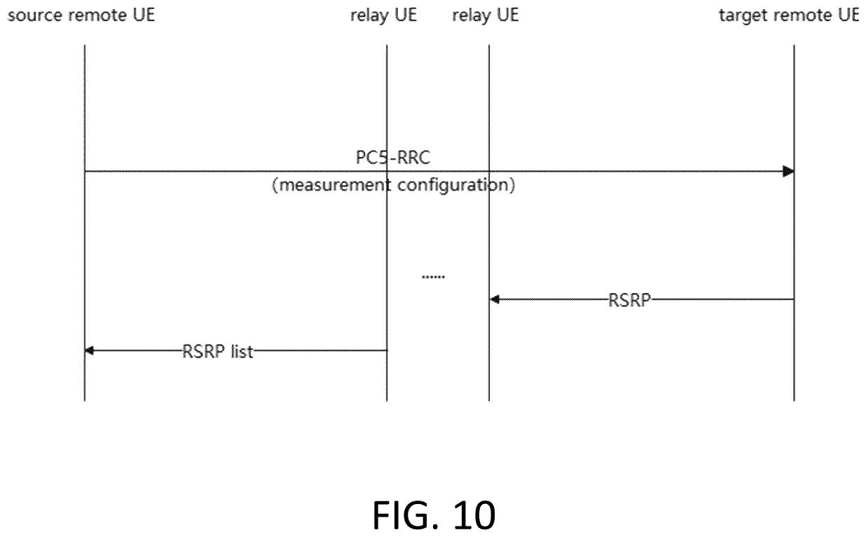

FIG. 10 shows a schematic diagram of a procedure associated with supporting per hop RSRP measurement and report (per hop configuration) according to an embodiment of the present disclosure. The procedure shown in FIG. 10 comprises:

Step 1001: The source UE sends an end-to-end PC5-RRC message comprising a measurement configuration (e.g., RRCReconfigurationSidelink - - - >sl-MeasConfig) to the target remote UE.

Step 1002: Upon/after receiving the measurement configuration from the source remote UE, the target remote UE reports measured RSRP of the last hop to a relay UE of the last hop. The measured RSRP report may be identified by at least one of an end-to-end PC5 link identifier, the source UE identifier or the target UE identifier.

Step 1003: Upon/after receiving the measurement result report from the target remote UE, the relay UE may generate a new measurement result report which include the received measured RSRP (list) and the measured RSRP of a previous hop in the PC5 link between the source remote UE and the target remote UE.

Step 1004: The source remote UE receives the measurement report from the relay UE of the first hop. That is the source remote UE receives per hop RSRP(s).

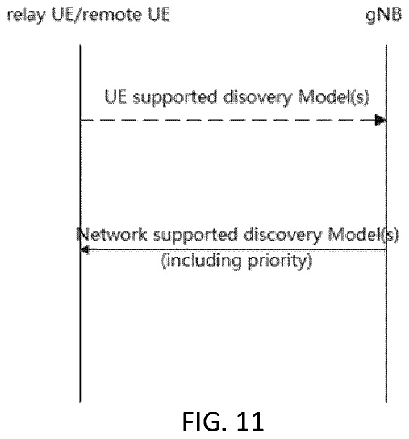

FIG. 11 shows a schematic diagram of a procedure associated with supporting discovery model capability according to an embodiment of the present disclosure. The procedure shown in FIG. 11 comprises:

Step 1101: The (relay/remote) UE may report the discovery model(s) supported by itself to gNB.

Step 1102: The gNB configures discovery model(s) that can be used by the UE or the support of UE-to-UE (U2U) relay. The configuration can be System Information or dedicated signaling. Moreover, for OOC (out of coverage) UE the configuration may be pre-configured.

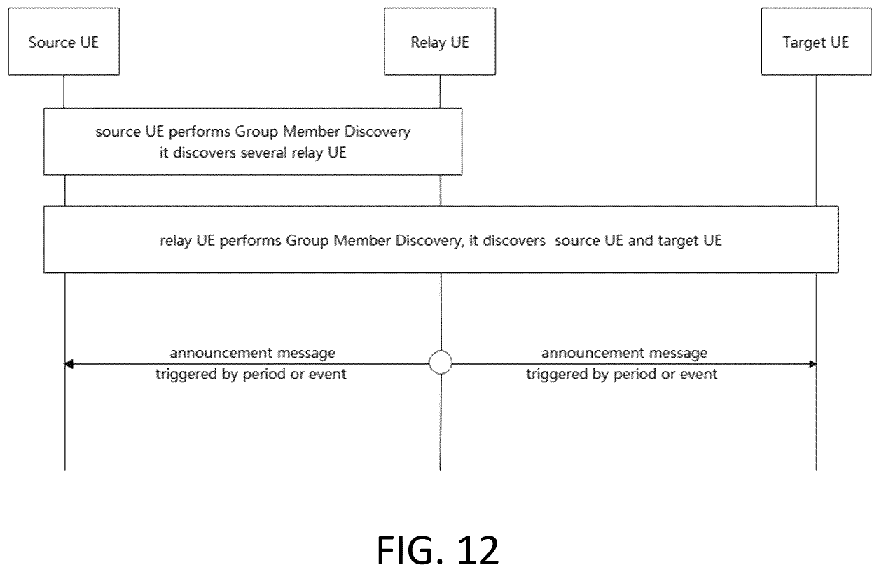

FIG. 12 shows a schematic diagram of a procedure associated with Model A U2U discovery according to an embodiment of the present disclosure. The procedure shown in FIG. 12 comprises:

Step 1001: The source UE performs a Group Member Discovery process (either Model A or Model B). In this process, the source UE discovers relay UEs as its neighbors (e.g., neighbor UEs).

Step 1002: The relay UE also performs the Group Member Discovery procedure (either Model A or Model B). In the process, the Relay UE discovers two UEs in vicinity: the source UE and the target UE.

Step 1003: The relay UE decides/determines that it can act as a U2U Relay and announces this by transmitting an announcement message periodically or when being triggered by event. In an embodiment, a precondition of acting as the U2U relay may comprise that the neighbor (UE) list is not empty. In embodiment, the announcement message may include the neighbor (UE) list of the relay UE. In an embodiment, the announcement message may further include RSRP between the relay UE and each neighbor (UE). In an embodiment, the neighbor (UE) on the list may need to meet certain conditions, e.g., the RSRP between relay UE and the neighbor (UE) is above a threshold. The period of transmitting the announcement message and/or the threshold can be configured by a network or in system information or via pre-configuration. For example, if the relay UE is out of network coverage, the period may be configured based on the pre-configuration. If the relay UE is in RRC IDLE/INACTIVE state, the period may be configured by the system information. If the relay UE is in RRC CONNECTED state, the period may be configured by system information. In an embodiment, the trigger event may comprise that a change in the neighbor list occurs.

Step 1004: Based on the information received in step 1003, the source UE decides to establish a one-to-one communication link with the relay UE and engage in communication with the target UE via the relay UE.

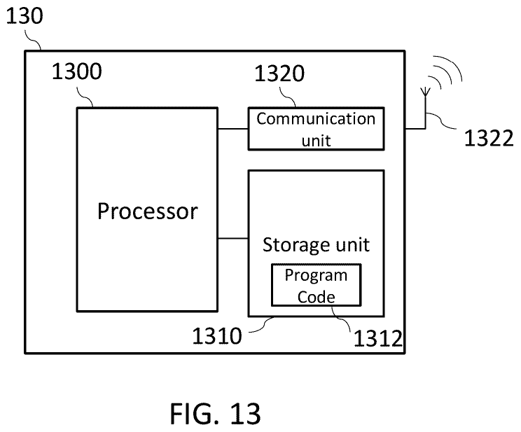

FIG. 13 relates to a schematic diagram of a wireless terminal 130 according to an embodiment of the present disclosure. The wireless terminal 130 may be a user equipment (UE), a mobile phone, a laptop, a tablet computer, an electronic book or a portable computer system and is not limited herein. The wireless terminal 130 may include a processor 1300 such as a microprocessor or Application Specific Integrated Circuit (ASIC), a storage unit 1310 and a communication unit 1320. The storage unit 1310 may be any data storage device that stores a program code 1312, which is accessed and executed by the processor 1300. Embodiments of the storage unit 1310 include but are not limited to a subscriber identity module (SIM), read-only memory (ROM), flash memory, random-access memory (RAM), hard-disk, and optical data storage device. The communication unit 1320 may a transceiver and is used to transmit and receive signals (e.g., messages or packets) according to processing results of the processor 1300. In an embodiment, the communication unit 1320 transmits and receives the signals via at least one antenna 1322 shown in FIG. 13.

In an embodiment, the storage unit 1310 and the program code 1312 may be omitted and the processor 1300 may include a storage unit with stored program code.

The processor 1300 may implement any one of the steps in exemplified embodiments on the wireless terminal 130, e.g., by executing the program code 1312.

The communication unit 1320 may be a transceiver. The communication unit 1320 may as an alternative or in addition be combining a transmitting unit and a receiving unit configured to transmit and to receive, respectively, signals to and from a wireless network node (e.g., a base station).

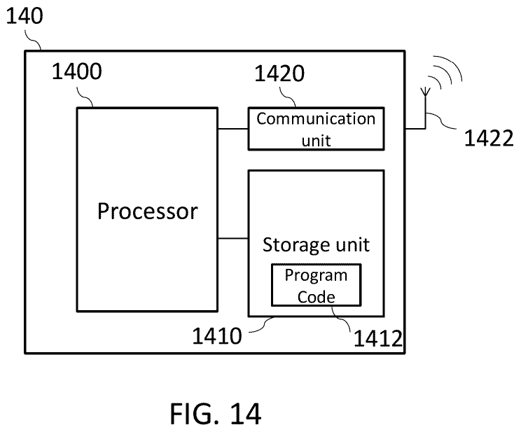

FIG. 14 relates to a schematic diagram of a wireless network node 140 according to an embodiment of the present disclosure. The wireless network node 140 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 140 may comprise (perform) at least one network function such as an access and mobility management function (AMF), a session management function (SMF), a user place function (UPF), a policy control function (PCF), an application function (AF), etc. The wireless network node 140 may include a processor 1400 such as a microprocessor or ASIC, a storage unit 1410 and a communication unit 1420. The storage unit 1410 may be any data storage device that stores a program code 1412, which is accessed and executed by the processor 1400. Examples of the storage unit 1410 include but are not limited to a SIM, ROM, flash memory, RAM, hard-disk, and optical data storage device. The communication unit 1420 may be a transceiver and is used to transmit and receive signals (e.g., messages or packets) according to processing results of the processor 1400. In an example, the communication unit 1420 transmits and receives the signals via at least one antenna 1422 shown in FIG. 14.

In an embodiment, the storage unit 1410 and the program code 1412 may be omitted. The processor 1400 may include a storage unit with stored program code.

The processor 1400 may implement any steps described in exemplified embodiments on the wireless network node 140, e.g., via executing the program code 1412.

The communication unit 1420 may be a transceiver. The communication unit 1420 may as an alternative or in addition be combining a transmitting unit and a receiving unit configured to transmit and to receive, respectively, signals to and from a wireless terminal (e.g., a user equipment or another wireless network node).

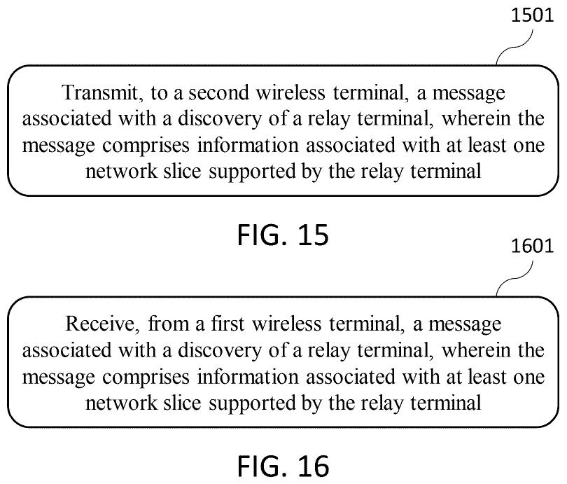

FIG. 15 shows a flowchart of a method according to an embodiment of the present disclosure. The method shown in FIG. 15 may be used in a first wireless terminal (e.g., first UE) and comprises the following step:

Step 1501: Transmit, to a second wireless terminal, a message associated with a discovery of a relay terminal, wherein the message comprises information associated with at least one network slice supported by the relay terminal.

In FIG. 15, the first wireless terminal transmits a message to a second wireless terminal, wherein the message is associated with a discovery of a relay terminal. In this embodiment, the message comprises information associated with at least one network slice supported by the relay terminal (e.g., a list of S-NSSAIs).

In an embodiment, the message is a discovery message. That is the first wireless terminal may be the relay terminal (see, e.g., FIG. 5). The second wireless terminal (e.g., remote UE) therefore can determine whether the first wireless terminal can be used as the relay terminal based on the information associated with at least one network slice.

In an embodiment, the message is a discovery solicitation message (see, e.g., FIG. 6). In this embodiment, the first wireless terminal may be a source (remote) terminal or a relay terminal and the second wireless terminal may be a relay terminal or a target (remote) terminal. Note that the at least one network slice supported by the relay terminal may refer to at least one network slice supported by the second wireless terminal in this embodiment.

In an embodiment, the message (discovery solicitation message) further comprises a relay indication indicating at least one of a number of hops of transmitting the message or a maximum number of hops of transmitting the message.

In an embodiment, the first wireless terminal may further receive a discovery response message from the second wireless terminal.

In an embodiment, the relay terminal is for a link between two wireless terminals (i.e., UE-to-UE relay) or between a wireless terminal and a wireless network node (i.e., UE-to-Network relay).

In an embodiment, the information of the at least one network slice comprises at least one signal network slice selection assistance information of the at least one network slice.

FIG. 16 shows a flowchart of a method according to an embodiment of the present disclosure. The method shown in FIG. 16 may be used in a second wireless terminal (e.g., second UE) and comprises the following step:

Step 1601: Receive, from a first wireless terminal, a message associated with a discovery of a relay terminal, wherein the message comprises information associated with at least one network slice supported by the relay terminal.

In FIG. 16, the second wireless terminal receives a message from a first wireless terminal, wherein the message is associated with a discovery of a relay terminal. In this embodiment, the message comprises information associated with at least one network slice supported by the relay terminal (e.g., a list of S-NSSAIs).

In an embodiment, the message is a discovery message. That is the first wireless terminal may be the relay terminal (see, e.g., FIG. 5). The second wireless terminal (e.g., remote UE) therefore can determine whether the first wireless terminal can be used as the relay terminal based on the information associated with at least one network slice.

In an embodiment, the message is a discovery solicitation message (see, e.g., FIG. 6). In this embodiment, the first wireless terminal may be a source (remote) terminal or a relay terminal and the second wireless terminal may be a relay terminal or a target (remote) terminal. Note that the at least one network slice supported by the relay terminal may refer to at least one network slice supported by the second wireless terminal in this embodiment. The second wireless terminal may determine whether to response the message based on the information of the at least one network slice.

In an embodiment, the message (discovery solicitation message) further comprises a relay indication indicating at least one of a number of hops of transmitting the message or a maximum number of hops of transmitting the message.

In an embodiment, the second wireless terminal supports the at least one network slice. Under such a condition, the second wireless terminal may transmit a discovery response message to the first wireless terminal. As an alternative or in addition, the second wireless terminal may transmit the message to a third wireless terminal (e.g., another relay UE of next hop or target UE). In this embodiment, the relay indication in the message transmitted to the third may be changed. For example, the number of hops of transmitting the message or the maximum number of hops of transmitting the message, which is indicated by the relay indication transmitted to the third wireless terminal, may be decreased/decremented by 1.

In an embodiment, the relay terminal is for a link between two wireless terminals (i.e., UE-to-UE relay) or between a wireless terminal and a wireless network node (i.e., UE-to-Network relay).

In an embodiment, the information of the at least one network slice comprises at least one signal network slice selection assistance information of the at least one network slice.

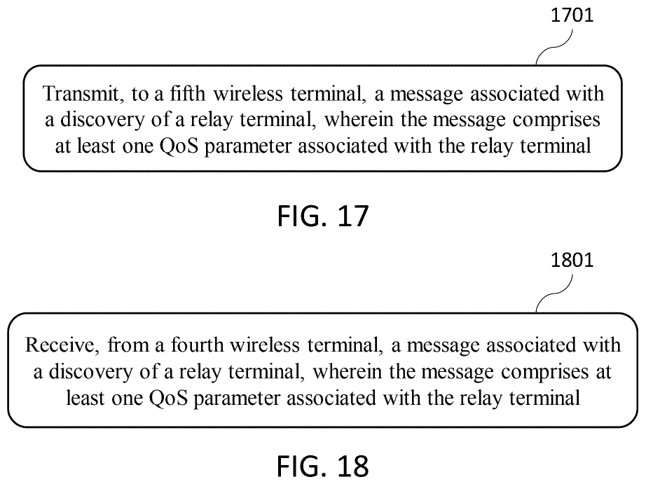

FIG. 17 shows a flowchart of a method according to an embodiment of the present disclosure. The method shown in FIG. 17 may be used in a fourth wireless terminal (e.g., fourth UE) and comprises the following step:

Step 1701: Transmit, to a fifth wireless terminal, a message associated with a discovery of a relay terminal, wherein the message comprises at least one QoS parameter associated with the relay terminal.

In FIG. 17, the fourth wireless terminal transmits a message to a fifth wireless terminal, wherein the message is associated with a discovery of a relay terminal. In this embodiment, the message comprises at least one QoS parameter associated with the relay terminal. Note that the method shown in FIG. 17 may be combined with that shown in FIG. 15. That is, the message may comprise both the information of the at least one network slice supported by the relay terminal and the at least one QoS parameter associated with the relay terminal.

In an embodiment, the message is a discovery message, a PC5 sidelink message or a PC5 RRC message (see, e.g., FIG. 7). In this embodiment, the fourth wireless terminal is the relay terminal. Based on the at least one QoS parameter, the fifth wireless terminal therefore can determine whether the fourth wireless terminal can be used as a relay. Note that, in this embodiment, the at least one QoS parameter may denote that supported by the relay terminal.

In an embodiment, the message is a discovery solicitation message, a PC5 sidelink message or a PC5 radio link control message (see, e.g., FIG. 8). In this embodiment, the fourth wireless terminal may be a source (remote) terminal or a relay terminal and the fifth wireless terminal may be a relay terminal or a target (remote) terminal. In addition, the at least one QoS parameter may denote at least one end-to-end QoS parameter for a link between a source terminal and a target terminal of the link or at least one remaining QoS parameter for a relay link between the fourth terminal and a target terminal of the relay link.

In an embodiment, the message further comprises a relay indication indicating at least one of a number of hops of transmitting the message or a maximum number of hops of transmitting the message.

In an embodiment, the fourth wireless terminal may receive a discovery response message from the fifth wireless terminal.

In an embodiment, the relay terminal is for a link between two wireless terminals (i.e., UE-to-UE relay) or between a wireless terminal and a wireless network node (i.e., UE-to-Network relay).

In an embodiment, the information of the at least one QoS parameter comprises at least one of a packet delay budget, a packet error rate, or a time stamp associated with a transmission the message.

FIG. 18 shows a flowchart of a method according to an embodiment of the present disclosure. The method shown in FIG. 18 may be used in a fifth wireless terminal (e.g., fifth UE) and comprises the following step:

Step 1801: Receive, from a fourth wireless terminal, a message associated with a discovery of a relay terminal, wherein the message comprises at least one QoS parameter associated with the relay terminal.

In FIG. 18, the fifth wireless terminal receives s a message from a fourth wireless terminal, wherein the message is associated with a discovery of a relay terminal. In this embodiment, the message comprises at least one QoS parameter associated with the relay terminal. Note that the method shown in FIG. 18 may be combined with that shown in FIG. 16. That is, the message may comprise both the information of the at least one network slice supported by the relay terminal and the at least one QoS parameter associated with the relay terminal.

In an embodiment, the message is a discovery message, a PC5 sidelink message or a PC5 RRC message (see, e.g., FIG. 7). In this embodiment, the fourth wireless terminal is the relay terminal. Based on the at least one QoS parameter, the fifth wireless terminal therefore can determine whether the fourth wireless terminal can be used as a relay. Note that, in this embodiment, the at least one QoS parameter may denote that supported by the relay terminal.

In an embodiment, the message is a discovery solicitation message, a PC5 sidelink message or a PC5 radio link control message (see, e.g., FIG. 8). In this embodiment, the fourth wireless terminal may be a source (remote) terminal or a relay terminal and the fifth wireless terminal may be a relay terminal or a target (remote) terminal. In addition, the at least one QoS parameter may denote at least one end-to-end QoS parameter for a link between a source terminal and a target terminal of the link or at least one remaining QoS parameter for a relay link between the fourth terminal and a target terminal of the relay link.

In an embodiment, the fifth wireless terminal supports the at least one QoS parameter (i.e., the fifth wireless terminal is capable of being the relay UE). In this embodiment, the fifth wireless terminal may transmit a discovery response message to the fourth wireless terminal. As an alternative or in addition, the fifth wireless terminal may transmit the message to a sixth wireless terminal (e.g., another relay UE of next hop or a target UE). Note that the at least one QoS parameter in the message transmitted to the sixth wireless terminal may remain the same or be changed/adjusted. For example, the at least one QoS parameter may remain the same if the at least one QoS parameter denotes the at least one end-to-end QoS parameter. The at least one QoS parameter may become the remaining QoS parameter from the fifth wireless terminal to the target wireless terminal if the at least one QoS parameter denotes the at least one remaining QoS parameter.

In an embodiment, the message further comprises a relay indication indicating at least one of a number of hops of transmitting the message or a maximum number of hops of transmitting the message.

In an embodiment, the relay terminal is for a link between two wireless terminals (i.e., UE-to-UE relay) or between a wireless terminal and a wireless network node (i.e., UE-to-Network relay).

In an embodiment, the information of the at least one QoS parameter comprises at least one of a packet delay budget, a packet error rate, or a time stamp associated with a transmission the message.

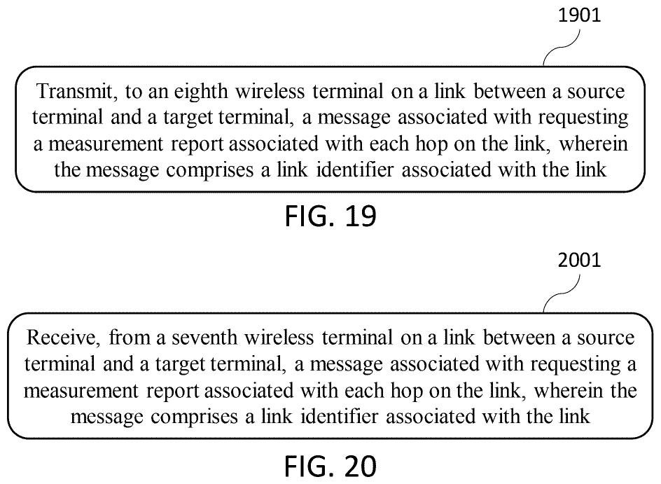

FIG. 19 shows a flowchart of a method according to an embodiment of the present disclosure. The method shown in FIG. 19 may be used in a seventh wireless terminal and comprises:

Step 1901: Transmit, to an eighth wireless terminal on a link between a source terminal and a target terminal, a message associated with requesting a measurement report associated with each hop on the link, wherein the message comprises a link identifier associated with the link.

In this embodiment, the seventh wireless terminal transmits a message to an eighth wireless terminal on a link between a source terminal and a target terminal, to request a measurement report associated with each hop on the link. The message comprises a link identifier of the link. Note that the seventh wireless terminal may be the source terminal or a relay terminal receiving the corresponding message from the source terminal or another relay terminal (see, e.g., FIG. 9).

In an embodiment, the message further comprises a relay indication configured to indicate a request for the measurement report associated with each hop on the link.

In an embodiment, the link identifier comprises at least one of an end-to-end PC5 link identifier of the link, an identifier of the source terminal or an identifier of the target terminal.

In an embodiment, the seventh wireless terminal receives the measurement report from the eighth wireless terminal. The measurement report is associated with each hop between the seventh wireless terminal and the target terminal. For example, the measurement report may comprise measurement results of each hop between the seventh wireless terminal and the target terminal.

In an embodiment, the seventh wireless terminal transmits the measurement report to a ninth wireless terminal (e.g., source terminal or a relay terminal of previous hop). The measurement report in this embodiment is associated with each hop between the ninth wireless terminal and the target terminal.

In an embodiment, the measurement report comprises (measurement results of) RSRP of each hop on the link.

FIG. 20 shows a flowchart of a method according to an embodiment of the present disclosure. The method shown in FIG. 20 may be used in an eighth wireless terminal and comprises:

Step 2001: Receive, from a seventh wireless terminal on a link between a source terminal and a target terminal, a message associated with requesting a measurement report associated with each hop on the link, wherein the message comprises a link identifier associated with the link.

In this embodiment, the eighth wireless terminal receives a message from a seventh wireless terminal on a link between a source terminal and a target terminal (or from the source terminal to the target terminal), to request a measurement report associated with each hop on the link. The message comprises a link identifier of the link. Note that the eighth wireless terminal may be the target terminal or a relay terminal on the link (see, e.g., FIG. 9).

In an embodiment, the message further comprises a relay indication configured to indicate a request for the measurement report associated with each hop on the link.

In an embodiment, the link identifier comprises at least one of an end-to-end PC5 link identifier of the link, an identifier of the source terminal or an identifier of the target terminal.

In an embodiment, the eighth wireless terminal may transmit the measurement report associated with each hop between the seventh wireless terminal and the target terminal.

In an embodiment, the eighth wireless terminal may further transmit the message associated with requesting the measurement report of each hop on the link to a tenth wireless terminal (e.g., the target terminal or another relay terminal on the link).

In an embodiment, the eighth wireless terminal may receive the measurement report associated with each hop between the eighth wireless terminal and the target terminal from the tenth wireless terminal.

In an embodiment, the measurement results comprise RSRP of each hop on the link.

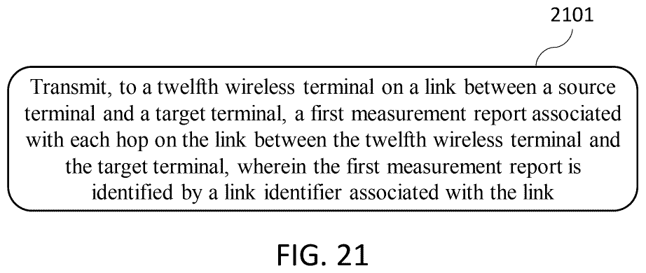

FIG. 21 shows a flowchart of a method according to an embodiment of the present disclosure. The method shown in FIG. 21 may be used in an eleventh wireless terminal and comprises:

Step 2101: Transmit, to a twelfth wireless terminal on a link between a source terminal and a target terminal, a first measurement report associated with each hop on the link between the twelfth wireless terminal and the target terminal, wherein the first measurement report is identified by a link identifier associated with the link.

In FIG. 21, the eleventh wireless terminal transmits a first measurement report to a twelfth wireless terminal on a link between a source terminal and a target terminal. The first measurement report is associated with each hop on the link between the twelfth wireless terminal the target terminal. In this embodiment, the eleventh wireless terminal may be the target terminal or a relay terminal on the link. The twelfth wireless terminal may be a relay terminal on the link. Note that the first measurement report is identified by a link identifier associated with the link.

In an embodiment, the link identifier comprises at least one of an end-to-end PC5 link identifier of the link, an identifier of the target terminal or an identifier of the source terminal.

In an embodiment, the eleventh wireless terminal may receive a configuration message associated with the measurement report from the source terminal. That is the eleventh wireless terminal may be the target wireless terminal (see, e.g., FIG. 10).

In an embodiment, the eleventh wireless terminal may receive a second measurement report associated with each hop on the link between the eleventh wireless terminal and the target terminal from a thirteenth wireless terminal (e.g., the target terminal or a relay terminal of next hop on the link towards the target terminal). The second measurement report is also identified by the link identifier associated with the link.

In an embodiment, the (first and/or second) measurement report comprises RSRP of each hop on the link.

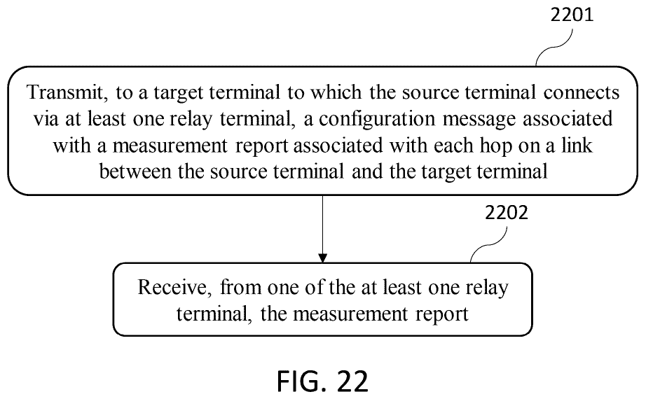

FIG. 22 shows a flowchart of a method according to an embodiment of the present disclosure. The method shown in FIG. 22 may be used in a source terminal (e.g., source (remote) UE) and comprises the following steps:

Step 2201: Transmit, to a target terminal to which the source terminal connects via at least one relay terminal, a configuration message associated with a measurement report associated with each hop on a link between the source terminal and the target terminal.

Step 2202: Receive, from one of the at least one relay terminal, the measurement report.

In this embodiment, the source terminal transmits a configuration message associated with a measurement report to a target terminal. The measurement report is associated with each hop on a link between the source terminal and the target terminal. In this embodiment, the source terminal connects to (or communicates with) the target terminal via at least one relay terminal. The source terminal therefore can receive the measurement report from one of the at least one relay terminal (see, e.g., FIG. 10).

In an embodiment, the measurement report comprises RSRP of each hop.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first wireless terminal, the wireless communication method comprising:
transmitting, to a second wireless terminal, a message associated with a discovery of a relay terminal,
wherein the message comprises information associated with at least one network slice supported by the relay terminal.

2. The wireless communication method of claim 1, wherein the message is a discovery message or wherein the message is a discovery solicitation message, and
wherein the first wireless terminal is the relay terminal.

3. The wireless communication method of claim 2, wherein the message further comprises a relay indication indicating at least one of a number of hops of transmitting the message or a maximum number of hops of transmitting the message, and
further comprising:
receiving, from the second wireless terminal, a discovery response message.

4. The wireless communication method of claim 1, wherein the relay terminal is for a link between two wireless terminals or between a wireless terminal and a wireless network node.

5. The wireless communication method of claim 1, wherein the information of the at least one network slice comprises at least one signal network slice selection assistance information of the at least one network slice.

6. A wireless communication method for use in a second wireless terminal, the wireless communication method comprising:
receiving, from a first wireless terminal, a message associated with a discovery of a relay terminal,
wherein the message comprises information associated with at least one network slice supported by the relay terminal.

7. The wireless communication method of claim 6, wherein the relay terminal is for a link between two wireless terminals or between a wireless terminal and a wireless network node.

8. A wireless communication method for use in a fourth wireless terminal, the wireless communication method comprising:
transmitting, to a fifth wireless terminal, a message associated with a discovery of a relay terminal,
wherein the message comprises at least one quality-of-service (QOS) parameter associated with the relay terminal.

9. The wireless communication method of claim 8, wherein the message is a discovery message, a PC5 sidelink message or a PC5 radio link control message, and
wherein the fourth wireless terminal is the relay terminal, and
wherein the at least one QoS parameter is supported by the relay terminal.

10. The wireless communication method of claim 8, wherein the message further comprises a relay indication indicating at least one of a number of hops of transmitting the message or a maximum number of hops of transmitting the message, and further comprising:
receiving, from the fifth wireless terminal, a discovery response message.

11. The wireless communication method of claim 8, wherein the at least one QOS parameter is at least one end-to-end QoS parameter for a link between a source terminal of the link and a target terminal of the link, or at least one remaining QoS parameter for a relay link between the fourth terminal and a target terminal of the relay link.

12. The wireless communication method of claim 8, wherein the relay terminal is for a link between two wireless terminals or between a wireless terminal and a wireless network node.

13. The wireless communication method of claim 8, wherein the at least one QoS parameter comprises at least one of a packet delay budget, a packet error rate, or a time stamp associated with a transmission the message.

14. A wireless communication method for use in a fifth wireless terminal, the wireless communication method comprising:
receiving, from a fourth wireless terminal, a message associated with a discovery of a relay terminal,
wherein the message comprises at least one quality-of-service, QoS, parameter associated with the relay terminal.

15. The wireless communication method of claim 14, wherein the relay terminal is for a link between two wireless terminals or between a wireless terminal and a wireless network node.

16. The wireless communication method of claim 14, wherein the at least one QoS parameter comprises at least one of a packet delay budget, a packet error rate or a time stamp associated with a transmission the message.

17. A first wireless terminal, comprising:
a communication unit, configured to implement the wireless communication method of claim 1.

18. A second wireless terminal, comprising:
a communication unit, configured to implement the wireless communication method of claim 6.

19. A fourth wireless terminal, comprising:
a communication unit, configured to implement the wireless communication method of claim 8.

20. A fifth wireless terminal, comprising:
a communication unit, configured to implement the wireless communication method of claim 14.
